(19) United States
(12) Patent Application Publication
(10) Pub. No.: US 2023/0030084 A1
(43) Pub. Date: Feb. 2, 2023

(54) ELEVATOR CONTROL UNIT AND A METHOD FOR TRANSFERRING DATA IN AN ELEVATOR ARRANGEMENT

(71) Applicant: KONE Corporation, Helsinki (FI)

(72) Inventors: Mika Belov, Helsinki (FI); Jere Vuorenala, Helsinki (FI); Raimo Kaartinen, Helsinki (FI); Claudio Stuppi, Helsinki (FI); Toni Kallio, Helsinki (FI)

(73) Assignee: KONE Corporation, Helsinki (FI)

(21) Appl. No.: 17/965,437

(22) Filed: Oct. 13, 2022

Related U.S. Application Data
(63) Continuation of application No. PCT/FI2020/050295, filed on May 4, 2020.

(51) Int. Cl. B66B 1/34; B66B 1/02

(52) U.S. Cl. CPC B66B 1/3461; B66B 1/02; B66B 9/00

(57) ABSTRACT

An elevator, an elevator control unit and a method for transferring data in an elevator arrangement, the elevator arrangement including at least an elevator shaft, an elevator car configured to move in the elevator shaft and at least one wireless communication channel, such as a wireless network, available for communication in the elevator shaft. The method includes determining signal quality and/or data transmission quality of the at least one wireless communication channel in different positions of the elevator car in the elevator shaft, moving the elevator car to a position or area selected based on the determined signal quality and/or the determined data transmission quality, and performing data transfer at the selected area or at the selected position of the elevator car.

### TECHNICAL FIELD

The invention relates to an elevator control unit and a method for transferring data in an elevator arrangement.

### BACKGROUND

The need for capacity for data transfer is growing constantly as new technologies and equipment are introduced to elevator environment. Therefore, the current solutions and technologies for transferring data in elevator environment can't meet the needs of the future.

The need for the increased data transfer capacity is caused for example by more and more applications installed in the elevator car, such as infotainment solutions, CCTV solutions, digital elevator cars, etc. Also, at the same time the modern buildings are more demanding environment for wireless communication as buildings have elements such as energy efficient windows which have effect on e.g. coverage of mobile networks.

For these reasons there is a need for improved solutions for transferring data in the elevator environment to achieve reliable and efficient data transfer for elevators and equipment related to elevator environment.

### SUMMARY

An object of the invention is to present a reliable and efficient data transfer solution for elevators and equipment related to elevator environment, e.g. installed in the elevator car.

According to a first aspect, the invention relates to a method for transferring data in elevator arrangement, the elevator arrangement comprising at least an elevator shaft, an elevator car able to move in the elevator shaft and at least one wireless communication channel, such as a wireless network, available for communication in the elevator shaft. The method comprises determining signal quality and/or data transmission quality of the at least one wireless communication channel in different positions of the elevator car in the elevator shaft, moving the elevator car to a position or area selected based on the determined signal quality and/or the determined data transmission quality, and performing data transfer at the said selected area or at the said selected position of the elevator car. In one embodiment of the invention, the elevator car is moved to the selected position or area in response to receiving a request or observing or determining a need for data transfer.

In one embodiment of the invention a first wireless communication unit is arranged to the elevator car and/or in connection with the elevator car and a second wireless communication unit, e.g. a wireless router, is arranged so that it has coverage in the elevator shaft, for example so that the second wireless communication unit is arranged in connection with the elevator shaft and/or to the elevator shaft. The second wireless communication unit may establish a wireless network and the first communication unit can communicate with the second communication unit via the at least one wireless communication channel, such as a wireless network. Thus, data can be transferred between an external server and the elevator system.

In one embodiment of the invention the selected position where the data transmission is carried out is a position or one of predefined positions, such as floors, where the determined signal quality and/or data transmission quality is the highest, such as the floor where the determined signal quality and/or data transmission quality is the highest.

In one embodiment of the invention the elevator car is parked to the selected position, such as to the selected floor, essentially always or based on predefined criteria when the elevator car is not in use.

In one embodiment of the invention determination of the signal quality and/or the data transmission quality of at least one wireless communication channel in different positions of the elevator car in the elevator shaft is carried out by measuring signal quality and/or data transfer quality when the elevator car is moving in the elevator shaft and/or continuously when the elevator is operating or at predefined time intervals during operation of the elevator.

In one embodiment of the invention the signal quality and/or the data transmission quality is determined at least in every floor.

In one embodiment of the invention the signal quality and/or the data transmission quality is determined by analyzing the measured signal level and/or data transfer quality by an elevator control unit and/or a cloud backend system, and/or based in the information from elevator commissioning software or other external system, such as a building control system.

In one embodiment of the invention determination of the signal quality and/or the data transmission quality is based on real time measurement and/or real time determination of the signal quality or data transmission quality.

In one embodiment of the invention information collected from the signal quality and/or data transmission quality determinations based on the time of the day and/or day of the earlier results of the signal quality and or data transfer quality determination are used when selecting the position of the elevator car for data transfer.

In one embodiment of the invention the signal quality and/or the data transmission quality is determined at different times of the day and the data transfer is carried out when the free capacity of the communication channel is above a predefined value or when there is most free capacity in the communication channel available for data transfer.

According to a second aspect, the invention relates to an elevator control unit of an elevator arrangement, the elevator arrangement comprising at least an elevator shaft, an elevator car configured to move in the elevator shaft and at least one wireless communication channel, such as a wireless network, available for communication in the elevator shaft, the elevator control unit comprising at least one processing unit, at least one memory. The elevator control unit is configured to control the elevator arrangement to determine signal quality and/or data transmission quality of the at least one wireless communication channel in different positions of the elevator car in the elevator shaft, to move the elevator car to a position or area selected based on the determined signal quality and/or the determined data transmission quality, and to perform data transfer at the said selected area or at the said selected position of the elevator car. In one embodiment of the invention, the elevator control unit is configured to cause the elevator car to move to the selected position or area in response to a received request for data transfer or a need for data transfer.

According to a third aspect, the invention relates to an elevator comprising an elevator car, an elevator motor configured to move the elevator car, and an elevator control unit according to the solution of the invention.

According to a fourth aspect, the invention relates to computer program comprising instructions which, when executed by a computer, cause the computer to carry out the method according to invention.

According to a fifth aspect, the invention relates to computer-readable medium comprising the computer program according to invention.

With the solution of the invention, signal level of wireless networks in different places and with different communication technologies can be monitored. Based on monitoring data wireless signal(s) coverage map(s) for e.g. all floors and all available communication technologies can be created. For example, when a new software update or data transfer is needed to be carried out, the system can select an optimal location of the elevator (or an optimal area) for data transfer, e.g. a synchronization zone. The data transfer location can be e.g. one of the floors. The elevator car is moved to the selected position and the data transfer can be started, e.g. for transferring data between an external server and the elevator system.

One embodiment of the invention the solution can comprise sub-components and/or functions such as signal level/quality monitor controller and/or cloud-based analytics/computing. In one embodiment of the invention the signal level/quality monitor controller or cloud backend system can analyze the measurements, such as wireless signal(s) coverage map(s), created by measuring the wireless signal for different technologies and/or in different locations, e.g. in all floors. The system can also utilize data available from a conveyor site system and/or other building solutions capable of providing required information. The coverage map can be based on real time data or information collected from the previous data sync cycles (e.g. based on the time of the day/day of the field strength statistics etc.).

In one embodiment of the invention, the devices and/or components requiring external connectivity can receive indication during normal use cycle that now data is available. As soon as possible the elevator system can send a call to elevator locally or through cloud API interface to move to selected location or area for starting the data transfer. In one embodiment of the invention, normal operation of the elevator can override the data transfer and/or moving to location for data transfer.

The invention provides benefits over the prior art solutions in the form of better and more reliable operation of data transfer for solutions requiring external, wireless connectivity. For example, in a case where the building's wireless coverage is not stable, the solution can be used for back reporting purposes for possible connectivity issues or to generate service or solution optimization request. This information can also be used to inform the application user carrying out the updating about the possible delay.

In one embodiment of the invention, in which the arrangement comprises multiple parallel connectivity solutions (e.g. master connectivity solution and backup connectivity solution based on different technology) the system can swap between the technologies to optimize the application operation.

In one embodiment of the invention software updates can be carried out when there is available capacity in the wireless network. In one example embodiment software updates and/or other data transfer requiring high transfer capacity is carried out within certain times of the day, e.g. during the nighttime, when there is high possibly for available extra capacity in the network. This information regarding available capacity can be determined during operation of the elevator and it doesn't have to be a fixed time or day, which is hard coded to the system. There are potential further benefits from this e.g. in the form of cheaper data deals, if it for example can be agreed with the network provider when the network can be used for bigger loads.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

The embodiments of the invention are illustrated by way of example, and not by way of limitation, in the figures of the accompanying drawings, in which:

FIG. 1 illustrates an elevator according to one embodiment of the invention, and

FIG. 2 presents a flow chart illustrating a method according to one embodiment of the invention.

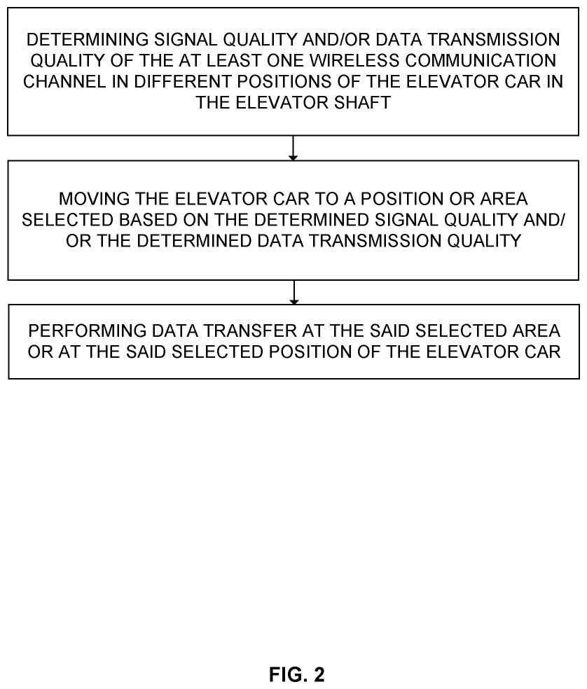

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

Reference will now be made in detail to the embodiments of the present invention, examples of which are illustrated in the accompanying drawings.

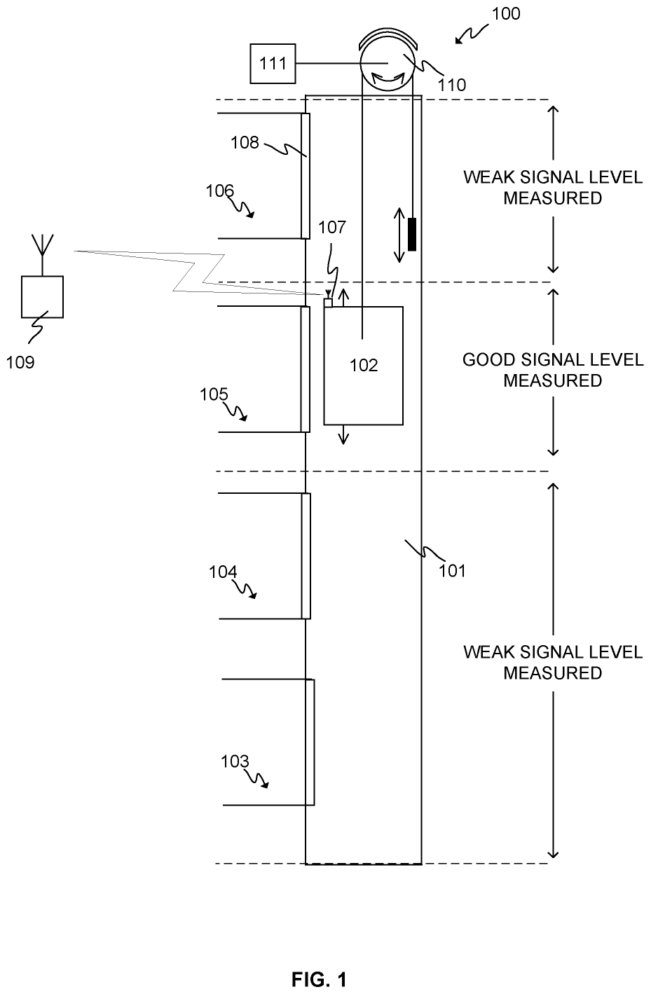

FIG. 1 illustrates an elevator system 100 according to one example embodiment of the invention. The elevator system comprises an elevator shaft 101 in which an elevator car 102 moves to serve different floors. In FIG. 1 only one type of elevator system is illustrated and described but the solution of the invention can be used for different kinds of elevators than what is described relating to FIG. 1. Although FIG. 1 illustrates four floors 103, 104, 105, 106, there may be any number of floors.

Similarly, although FIG. 1 illustrates only one elevator shaft 102, there may be more than one elevator shaft in the elevator system. In the elevator system 100 illustrated in FIG. 1, there is one side towards which landing doors 108 at each floor can be opened. Although FIG. 1 illustrates one side, in another embodiment it is possible that the elevator car has doors towards more than one side of the elevator car 102.

The elevator car 102 is configured to perform a travel in the elevator shaft 101, wherein the elevator car is moved in this example by a motor 110. The term “travel” may refer to a process where the elevator car 102 may be configured to move in the elevator shaft 101 so that each floor is passed or visited at least once, i.e. the elevator car 102 can perform an end-to-end travel. In another embodiment, the travel in the elevator shaft 101 may not be a complete end-to-end travel. For example, it may not be possible to travel to one or more of the floors, for example, to the uppermost or the lowermost floor. The elevator system can comprise a controller 111 configured to control the movement of the elevator, and e.g. the motor.

In one embodiment of the invention a first wireless communication unit 107 is arranged to the elevator car and/or in connection with the elevator car. A second wireless communication unit 109, e.g. a wireless router, is arranged so that it has coverage in the elevator shaft, for example so that the second wireless communication unit is arranged in connection with the elevator shaft and/or to the elevator shaft. The second wireless communication unit 109 may establish a wireless network and the first communication unit 107 can communicate with the second communication unit 109 via the at least one wireless communication channel, such as a wireless network. At least one wireless antenna can be connected to the at least one wireless communication unit, e.g. the router. The solution of the invention can utilize different kind of wireless technologies, such as cellular network communication, WLAN, wireless sensor network, e.g. Bluetooth, Zigbee, etc. In a case where multiple different communication methods are used, the elevator system can be connected, e.g. the controller can be connected, to different communication units of different communication methods.

In the solution of the invention at least one wireless communication channel is arranged in connection with the elevator and/or the elevator shaft, such as a wireless network, available for communication in the elevator shaft. In the solution of the invention, signal quality and/or data transmission quality of the at least one wireless communication channel is determined and recorded in different positions of the elevator car in the elevator shaft. Based on this it can be known what the signal quality and/or data transfer quality is in different parts of the elevator shaft and/or at different positions of the elevator car. In the example of FIG. 1 the signal quality is weak in the uppermost floor but good at the floor below the uppermost floor. At the two lowest floors the signal quality is weak in this example. There can be e.g. certain signal levels or quality levels predefined in the system, for example so that the signal is determined to be weak if the signal level and/or quality is below certain threshold value, and/or the signal is determined to be good if the signal level and/or quality is above certain threshold value.

In the solution of the invention, when there is a need for data transfer and/or the elevator receives a request for data transfer, the elevator car moves to a position or area selected around the selected position based on the determined signal quality and/or the determined data transmission quality. In one embodiment of the invention the elevator car can go to the selected position even before or without need or request for data transfer so that if there would come a need or request for data transfer, the elevator would already be in the correct position. The selected position can be e.g. a position or area around the position where the signal quality was highest and/or above a predetermined level. In one embodiment the position may be the floor where the signal quality and/or the data transfer quality was determined as the best and/or where it was above a predefined level.

After the elevator car has been moved to the selected position and/or around the selected position, i.e. within a certain distance from the selected position, the data transfer can be started. In one embodiment of the invention, the data transfer can be paused or stopped if the elevator car has to move and elevator car can return to the selected position when it is free, i.e. available for data transfer.

In one embodiment of the invention, elevator car is parked to the selected position or around the selected position, e.g. a selected floor, when not in use. Optimal parking zone can be automatically changed e.g. if better signal is detected on some other floor.

In one embodiment of the invention there can be multiple wireless communication technologies and/or means used and the signal quality and/or data transfer quality measurement can be done separately to all different communication technologies and means. In this case there can be different optimal positions for data transfer for different communication technologies and communication means.

In one embodiment of the invention the selected position where the data transmission is carried out is a position or one of predefined positions, such as floors, where the determined signal quality and/or data transmission quality is the highest, such as the floor where the determined signal quality and/or data transmission quality is the highest. In one embodiment of the invention the stopping point may not be the exact location of the elevator car at which it would normally stop when carrying passengers.

In one embodiment of the invention determination of the signal quality and/or the data transmission quality of at least one wireless communication channel in different positions of the elevator car in the elevator shaft is carried out by measuring signal quality and/or data transfer quality when the elevator car is moving in the elevator shaft and/or continuously when the elevator is operating or at predefined time intervals during operation of the elevator.

In one embodiment of the invention the system can be triggered to determine the signal and/or data transfer quality constantly or during a certain intervals, e.g. during normal operation of the elevator, i.e. when the elevator is moving in the elevator shaft and/or when the elevator stops at different floors. In one embodiment, the wireless signal measurement can be triggered to be performed when the elevator car has been parked at a certain floor and/or its door has been opened.

In one embodiment of the invention the signal quality and/or the data transmission quality is determined at least in every floor.

In one embodiment of the invention the signal quality and/or the data transmission quality is determined by analyzing the measured signal level and/or data transfer quality by an elevator control unit and/or a cloud backend system, and/or based in the information from elevator commissioning software or other external system, such as a building control system.

In one embodiment of the invention determination of the signal quality and/or the data transmission quality is based on real time measurement and/or real time determination of the signal quality or data transmission quality.

The wireless communication unit arranged in connection with the elevator car can determine and/or send data associated with the wireless signal strength values of the wireless network and/or connection. The elevator car mounted wireless device may send the data to the elevator controller in a single transmission after the travel has been performed. In another embodiment, the data may be sent to the elevator controller after each stop.

When determining the signal quality in the elevator shaft, as an example, the first wireless communication unit arranged to the elevator car or in connection with the elevator car may record wireless signal strength or quality and/or the data transfer quality as the elevator car is moving in the elevator shaft. It can be recorded e.g. that “at floor Y with side Z side door open the signal strength was N dBm” or “wireless signal strength at floor Y was N dBm”. In one embodiment a timestamp is also recorded with the signal quality and/or data transfer quality data indicating the time when the wireless signal strength or quality was recorded. This means that multiple (separate) entries for a certain location can be recorded.

In one embodiment of the invention information collected from the signal quality and/or data transmission quality determinations based on the time of the day and/or day of the earlier results of the signal quality and or data transfer quality determination are used when selecting the position of the elevator car for data transfer.

In one embodiment of the invention the signal quality and/or the data transmission quality is determined at different times of the day and the data transfer is carried out when the free capacity of the communication channel is above a predefined value or when there is most free capacity in the communication channel available for data transfer.

In one embodiment of the invention at least one door towards the side can be opened when preparing and/or carrying out data transfer. This can be advantageous in certain circumstances in which the signal or data transfer quality can be better when the elevator door is opened than when it is closed. This can be due to signal attenuation as the wireless signals attenuate when traveling through an obstacle, such as a closed door (elevator car and/or landing doors) or a floor/ceiling of the elevator car or a building.

A controller of an elevator system which can be used in one embodiment of the invention may comprise at least one processor connected to at least one memory. The at least one memory may comprise at least one computer program which, when executed by the processor or processors, causes the controller to perform the programmed functionality. In another embodiment, the at least one memory may be an internal memory of the at least one processor. The controller may also comprise an input/output interface. Via the input/output interface, the control apparatus may be connected to at least one wireless device. The controller may be a control entity configured to implement only the above disclosed operating features, or it may be part of a larger elevator control entity, for example, an elevator controller or an elevator group controller.

As stated above, the components or other parts of the exemplary embodiments can include computer readable medium or memories for holding instructions programmed according to the teachings of the present embodiments and for holding data structures, tables, records, and/or other data described herein. Computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD1RW, DVD±R, HD DVD, HD DVD-R, HD DVD-RW, HD DVD-RAM, Blu-ray Disc, any other suitable optical medium, a RAM, a PROM, an EPROM, a FLASH-EPROM, any other suitable memory chip or cartridge or any other suitable medium from which a computer can read.

It is obvious to a person skilled in the art that with the advancement of technology, the basic idea of the optically readable comprising parameters may be implemented in various ways. The optically readable code arranged in connection with a conveyor component and its embodiments are thus not limited to the examples described above; instead they may vary within the scope of the claims. While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore in association with the figures presented and the summary of the invention may be used in any combination with each other. At least two of the embodiments may be combined together to form a further embodiment of the invention.

The specific examples provided in the description given above should not be construed as limiting the applicability and/or the interpretation of the appended claims. Lists and groups of examples provided in the description given above are not exhaustive unless otherwise explicitly stated.

1. A method for transferring data in an elevator arrangement, the elevator arrangement comprising at least an elevator shaft, an elevator car configured to move in the elevator shaft and at least one wireless communication channel available for communication in the elevator shaft,
wherein the method comprises:
determining signal quality and/or data transmission quality of the at least one wireless communication channel in different positions of the elevator car in the elevator shaft;
moving the elevator car to a position or area selected based on the determined signal quality and/or the determined data transmission quality; and
performing data transfer at said selected area or at said selected position of the elevator car.

2. The method according to claim 1, wherein the selected position where the data transmission is carried out is a position or one of predefined positions, where the determined signal quality and/or data transmission quality is the highest.

3. The method according to claim 1, wherein the elevator car is parked to the selected position, essentially always or based on predefined criteria when the elevator car is not in use.

4. The method according to claim 1, wherein the step of determining the signal quality and/or the data transmission quality of at least one wireless communication channel in different positions of the elevator car in the elevator shaft is carried out by measuring signal quality and/or data transfer quality when the elevator car is moving in the elevator shaft and/or continuously when the elevator is operating or at predefined time intervals during operation of the elevator.

5. The method according to claim 1, wherein the signal quality and/or the data transmission quality is determined at least in every floor.

6. The method according to claim 1, wherein the signal quality and/or the data transmission quality is determined by analyzing the measured signal level and/or data transfer quality by an elevator control unit and/or a cloud backend system, and/or based in the information from elevator commissioning software or other external system.

7. The method according to claim 1, wherein the step of determining the signal quality and/or the data transmission quality is based on real time measurement and/or real time determination of the signal quality or data transmission quality.

8. The method according to claim 1, wherein information collected from the signal quality and/or data transmission quality determinations based on the time of the day and/or day of the earlier results of the signal quality and or data transfer quality determination are used when selecting the position of the elevator car for data transfer.

9. The method according to claim 1, wherein the signal quality and/or the data transmission quality is determined at different times of the day and the data transfer is carried out when the free capacity of the communication channel is above a predefined value or when there is most free capacity in the communication channel available for data transfer.

10. An elevator control unit of an elevator arrangement, the elevator arrangement comprising at least an elevator shaft, an elevator car configured to move in the elevator shaft and at least one wireless communication channel available for communication in the elevator shaft, the elevator control unit comprising at least one processing unit, and at least one memory,
wherein the elevator control unit is configured to control the elevator arrangement to:
determine signal quality and/or data transmission quality of the at least one wireless communication channel in different positions of the elevator car in the elevator shaft,
move the elevator car to a position or area selected based on the determined signal quality and/or the determined data transmission quality, and
perform data transfer at the said selected area or at the said selected position of the elevator car.

11. The elevator control unit according to claim 10, wherein the selected position where the elevator control unit is configured to control the arrangement to carry out data transmission is a position or one of predefined positions, where the determined signal quality and/or data transmission quality is the highest.

12. The elevator control unit according to claim 10, wherein the elevator control unit is configured to control the elevator arrangement to park the elevator car to the selected position, essentially always or based on predefined criteria when the elevator car is not in use.

13. The elevator control unit according to claim 10, wherein the elevator control unit is configured to control the elevator arrangement to carry out determination of the signal quality and/or the data transmission quality of at least one wireless communication channel in different positions of the elevator car in the elevator shaft by measuring signal quality and/or data transfer quality when the elevator car is moving in the elevator shaft and/or continuously when the elevator is operating or at predefined time intervals during operation of the elevator.

14. The elevator control unit according to claim 10, wherein the elevator control unit is configured to control the elevator arrangement to determine the signal quality and/or the data transmission quality is at least in every floor.

15. The elevator control unit according to claim 10, wherein the elevator control unit is configured to analyze the measured signal level and/or data transfer quality for determining the signal quality and/or the data transmission quality by analyzing the measured signal level and/or measured data transfer quality, and/or to control the elevator arrangement to determine the signal quality and/or the data transmission quality by analyzing the measured signal level and/or data transfer quality by a cloud backend system, and/or based in the information from elevator commissioning software or other external system.

16. The elevator control unit according to claim 10, wherein determination of the signal quality and/or the data transmission quality is based on real time measurement and/or real time determination of the signal quality or data transmission quality.

17. The elevator control unit according to claim 10, wherein the elevator control unit is configured to control the elevator arrangement to use information collected from the signal quality and/or data transmission quality determinations based on the time of the day and/or day of the earlier results of the signal quality and/or data transfer quality determinations when selecting the position of the elevator car for data transfer.

18. The elevator control unit according to claim 10, wherein the elevator control unit is configured to control the elevator arrangement to determine the signal quality and/or the data transmission quality at different times of the day and to carry out the data transfer when the free capacity of the communication channel is above a predefined value or when there is most free capacity in the communication channel available for data transfer.

19. An elevator comprising:
an elevator car;
an elevator motor configured to move the elevator car; and
the elevator control unit of claim 10.

20. A computer program embodied on a non-transitory computer readable medium and comprising instructions which, when executed by a computer, cause the computer to carry out the method according to claim 1.

21. (canceled)
